(19) United States
(12) Patent Application Publication
(10) Pub. No.: US 2005/0212351 A1
(43) Pub. Date: Sep. 29, 2005

(54) Wheel support system and ornamental accessory

(76) Inventor: Ian McKay, Minitonas (CA)

Correspondence Address: Ryan W. Dupuis;Ade & Company, 1700-360 Main Street, Winnipeg, MB, R3C 3Z3, CA

(21) Appl. No.: 11/091,463

(22) Filed: Mar. 29, 2005

Related U.S. Application Data
(60) Provisional application No. 60/556,898, filed on Mar. 29, 2004.

(51) Int. Cl. B60B 27/00

(52) U.S. Cl. 301/110.5

(57) ABSTRACT

A wheel support system for a two wheeled vehicle comprises front and rear axles fixed for rotation with the front and rear wheels respectively and bearings on the frame of the vehicle which rotatably supporting the axles therein. Ornamental members are supported on respective free ends of the axles for rotation relative to the frame. The ornamental members are aesthetically pleasing and shield the view of the bearings on the forks for a better overall finished appearance of the frame of a motorcycle or bicycle. By supporting the axle within bearings on the frame with the ornamental members supported on the axle, the ornamental members are permitted to rotate relative to the frame. In order to ensure the rear axle position can be adjusted relative to the engine for adjusting tension to the drive train in a motorcycle, the bearings supporting the rear axle are adjustably supported on the frame relative to the engine.

### FIELD OF THE INVENTION

The present invention relates to a wheel support system for supporting the wheels onto the frame of a two wheeled vehicle and more particularly relates to an ornamental accessory which can be displayed on the wheel support system.

### BACKGROUND

For decades, motorcycle enthusiasts have customized their motorcycles by adding or removing components to give their motorcycles a unique and customized look. Aftermarket components like fuel tanks, handle bars, frames, suspensions, and wheels have provided a lucrative market for companies specializing in custom motorcycle component parts.

The basic design of the front and rear axles has largely remained unchanged. The front axle is generally held secure by a clamping mechanism built into the front fork tubes. Bearings are fitted into the wheel hub which allow the wheel, through the bearings, to rotate about the axle shaft fixed on the fork tubes.

The rear axle is also fixed to the frame where once again bearing clusters are pressed into the wheel hub which allow the wheel to rotate about the axle. Since a chain or belt system is generally used to provide the motive force to the rear wheel, the axle not only must be held secure, but also must employ a method of tensioning the drive medium and aligning the rear wheel to the geometry of the motorcycle itself.

U.S. Pat. Nos. 2,018,973 to Pomeroy and 4,632,415 to San Hai disclose front forks of a bicycle frame in which bearings are supported on the frame for rotatably supporting an axle fixed to the front wheel of the bicycle therein, contrary to conventional designs. This configuration however lacks suitable strength for use in heavier motorcycles and the like. Furthermore the configuration is aesthetically unappealing at each end of the axle due to the large bearings required to be supported in the forks of the frame.

### SUMMARY

According to the present invention there is provided a wheel support system for a two wheeled vehicle having a frame including a front wheel mount and a rear wheel mount each supporting a respective wheel therein, the system comprising:
at least one axle fixed for rotation with a respective one of the wheels;
bearings rotatably supporting said at least one axle on the respective wheel mount of the frame for rotation of said at least one axle in relation to the frame;
a pair of ornamental members supported on respective free ends of said at least one axle for rotation relative to the frame.

The use of an ornamental member supported on the axle provides an aesthetically pleasing member which shields view of the bearings on the forks for a better overall finished appearance of the frame of a motorcycle or bicycle. By supporting the axle within bearings on the frame with the ornamental member supported on the axle, the ornamental member is permitted to rotate relative to the frame when suitable mounting means are provided.

The ornamental members are preferably keyed for rotation with said at least one axle and are secured to said at least one axle by threaded fastening means.

Said at least one axle preferably projects axially outward beyond the respective bearings at each end of the axle.

The system may comprise a kit for modifying a conventional wheel rotatably supporting a conventional axle therein with conventional bearings, in which said at least one axle includes mounting means for fixing the axle in place of the conventional bearings for rotation with the wheel and wherein there is provided a modified wheel mount supporting the bearings which rotatably support said at least one axle therein.

According to a second aspect of the present invention there is provided a wheel support system for a two wheeled vehicle having a frame supported on a front wheel and a rear wheel and which supports an engine thereon, the system comprising:
an axle supporting the rear wheel thereon; and
a rear wheel mount including a pair of discs, each having a bore formed therein which is parallel to and radially offset from a central axis of the respective disc which receives a respective end of the axle therein and each being supported on the frame for rotation about the central axis thereof;
whereby distance between the axle and the engine is varied as the discs are rotated relative to the frame.

Preferably there is provided locking means for selectively restricting rotation of the discs relative to the frame wherein the locking means includes a worm gear engaging peripheral teeth on each disc to control rotational position of the discs.

The axle may be fixed to the rear wheel for rotation therewith by providing bearings rotatably supporting the axle within the bores in the discs.

There may be provided a pair of ornamental members supported on respective free ends of the axle for rotation relative to the frame.

According to a further aspect of the present invention there is provided a method of modifying a motorcycle comprising a frame, a front wheel rotatably supported on a front axle mounted on a front wheel mount and a rear wheel rotatably supported on a rear axle mounted on a rear wheel mount, the method comprising:
fixing at least one axle to rotate with the respective wheel;
supporting said at least one axle for rotation relative to the respective wheel mount.

The method preferably includes supporting said at least one axle to extend axially outward beyond the respective wheel mount and supporting an ornamental member at each end of said at least one axle, in which the ornamental members are fixed to rotate with said at least one axle.

### BRIEF DESCRIPTION OF THE DRAWINGS

In the accompanying drawings, which illustrate an exemplary embodiment of the present invention:

FIG. 1, FIG. 2 and FIG. 3 are respective side elevational, front elevational and perspective views of the front wheel of a motorcycle incorporating the wheel support system of the present invention therein.

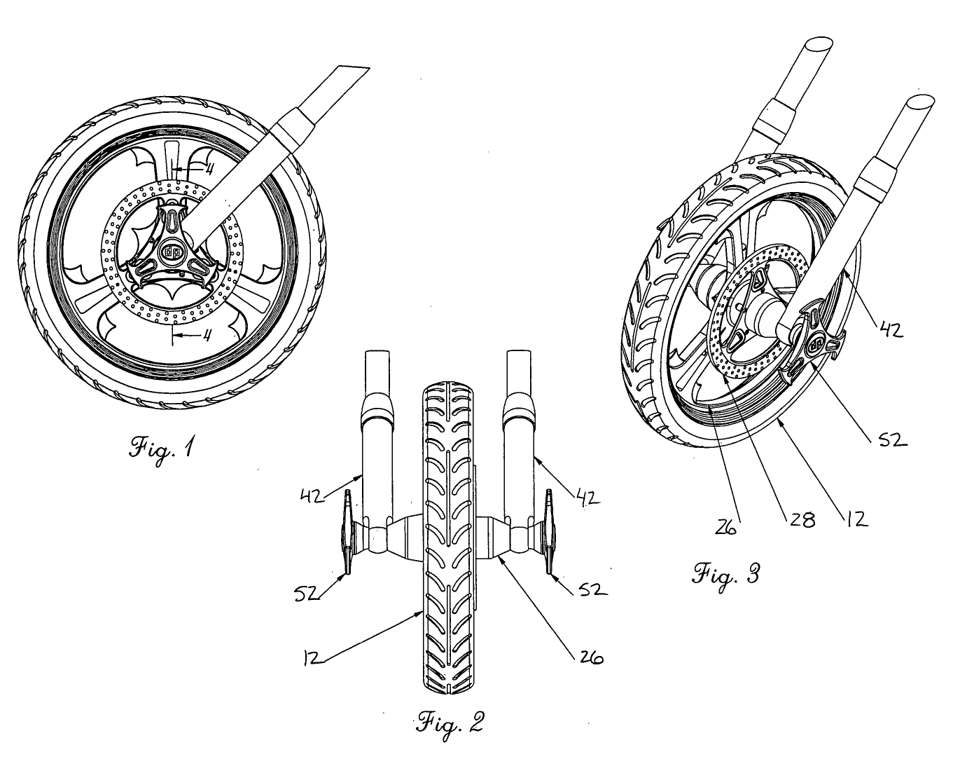

FIG. 4 is a sectional view along the line 44 of FIG. 1.

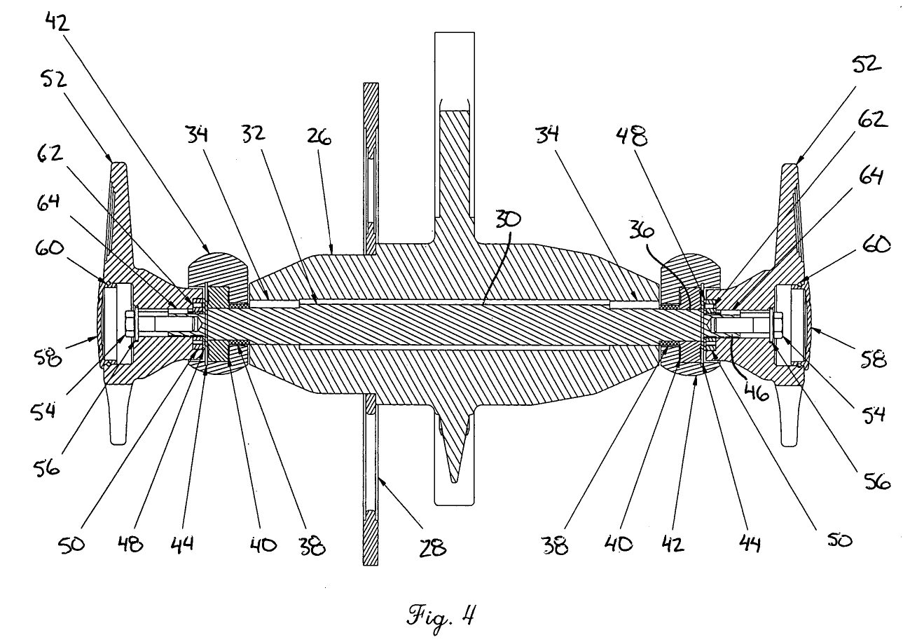

FIG. 5 is an exploded perspective view of the components of the wheel support system of the front wheel of FIG. 1.

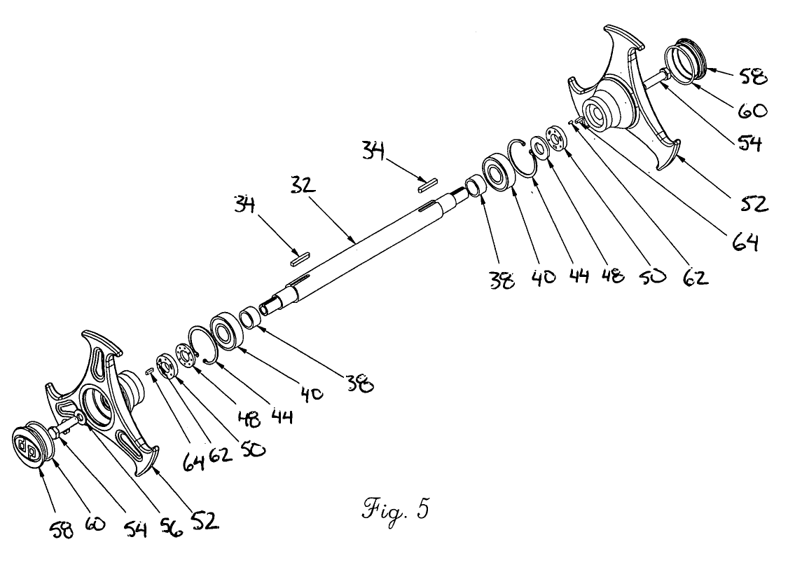

FIG. 6, FIG. 7 and FIG. 8 are respective side elevational, front elevational and perspective views of the rear wheel of a motorcycle incorporating the wheel support system therein.

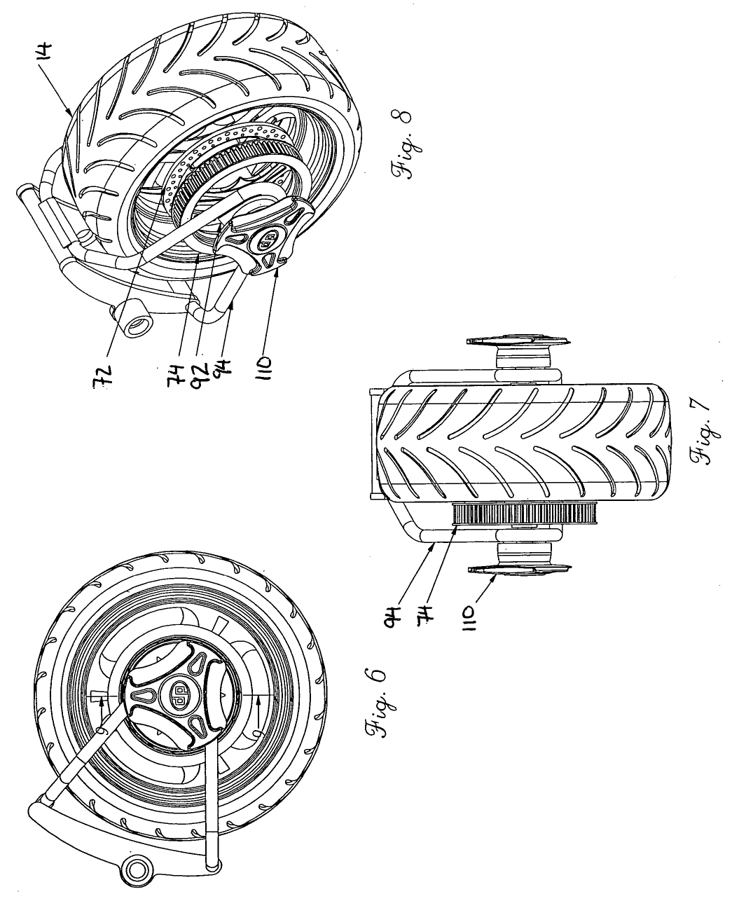

FIG. 9 is a sectional view along the line 9-9 of FIG. 6.

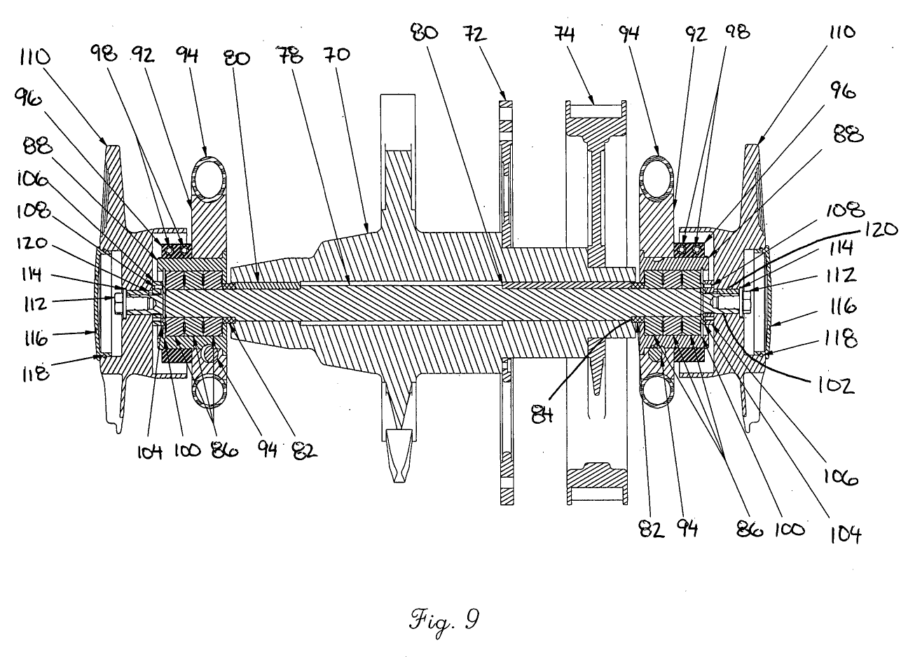

FIG. 10 is an exploded perspective view of the components of the wheel support system of the rear wheel of FIG. 6.

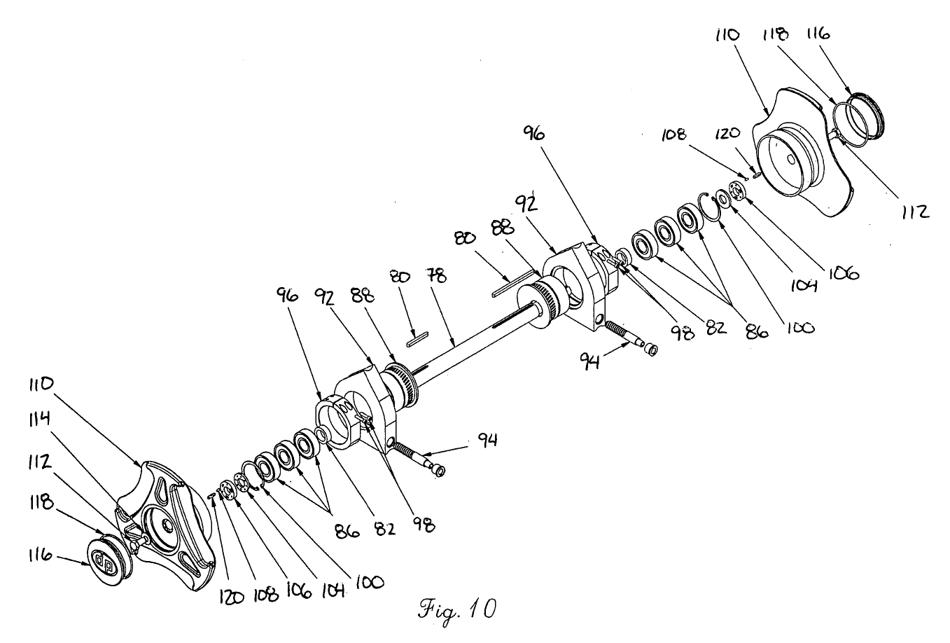

FIG. 11 is a schematic side elevational view of a motorcycle including the front and rear wheels in accordance with FIG. 1 and FIG. 6 respectively.

### DETAILED DESCRIPTION

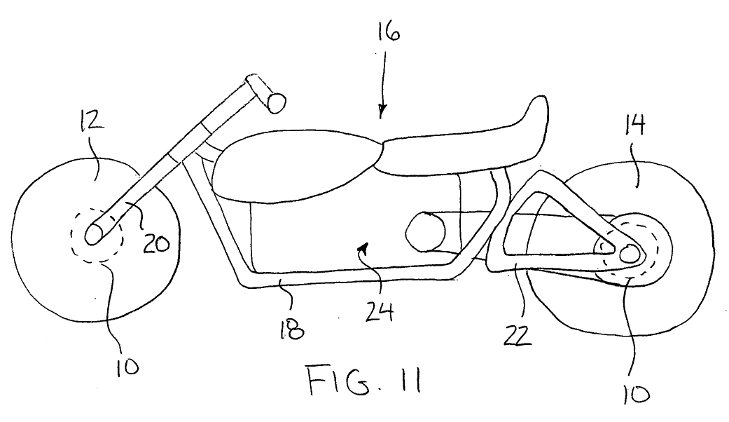

Referring to the accompanying figures, there is illustrated a wheel support system generally indicated by reference numeral 10. The system 10 may be supported on either the front wheel 12 or the rear wheel 14 of a two wheeled vehicle, for example a motorcycle 16 as illustrated in FIG. 11.

The motorcycle 16 is similar to conventional designs including a frame 18 having a front wheel mount 20 supporting the front wheel 12 thereon and a rear wheel mount 22 supporting the rear wheel 14 thereon. An engine 24 is supported on the frame 18 for driving rotation of the rear wheel 14.

The wheel support system 10 at the front wheel 12 includes a modified wheel rim 26 which supports a brake rotor 28 thereon similar to conventional motorcycle wheels. A through bore 30 is coaxially received through the wheel rim 26 for receiving the axle 32 of the wheel therethrough. Slots are provided at each end of the axle for receiving a respective key 34 therein such that the axle is fixed for rotation with the wheel rim 26.

Each end of the axle 32 includes a first portion 36 of reduced diameter which extends axially outward beyond the wheel rim. A spacer bushing 38 is received about the first portion 36 at each end of the axle for providing proper spacing between a shoulder formed in the axle at each end of the rim and the bearing 40 which is also supported about the first portion 36 of reduced diameter of the axle.

The bearing 40 is surrounded by the bottom end of the lower fork tube 42 on each side of the wheel for supporting the axle and wheel carried thereon rotatably on the frame of the vehicle. A snap ring 44 internally mounts within the bottom end of each fork tube for retaining the bearing 40 therein.

At each end of the axle a second portion 46 of reduced diameter extends axially outward which is further reduced in diameter in relation to the first portion 36 and which includes a slot formed therein for engagement by a keyed locking insert 48. An axle nut 50 secures to the keyed locking insert which provides further backing for retaining the bearings fixed on the axle.

The second portion 46 of reduced diameter projects axially beyond the fork tubes 42 forming the front wheel mounts 20 for securing an ornamental member 52 thereon. An axial bore is located at each end of the axle for receiving a mounting bolt 54 threadably therein.

The ornamental member 52 includes a recess formed at an internal end for surrounding the lock nut 50 and a through bore which receives the mounting bolt 54 therethrough. A suitable washer 56 engages the head of the bolt on the ornamental member at an outer end of the through bore which is formed as a recess receiving a suitable cap member 58 with sealing O-ring 60 therein to fully conceal the mounting hardware of the ornamental member and the bearings within the front wheel mount.

The axle nut 50 is secured to the keyed locking insert by suitable set screws 62 while the ornamental member 52 is keyed to the axle by a slot in the second portion 46 of reduce diameter which receives a suitable key 64 therein so that all components of the wheel and ornamental member rotate together in relation to the fork tube of the front wheel mount by means of bearings 40 at each end of the axle.

The rear wheel similarly includes a wheel rim 70 which carries a rotor 72 for the rear brakes similar to conventional wheel designs. The rear rim also carries a drive pulley 74 which couples to the vehicle engine 24 by a suitable drive belt.

A through bore 76 is received concentrically through the wheel rim for receiving an axle 78 therein similarly to the front wheel. The axle includes slots formed at each end thereof for receiving respective keys 80 which fix rotation of the axle with the wheel rim.

Beyond the keys formed in the slots at each end of the axle, the axle includes a first portion of reduced diameter 84 which projects in an axial direction beyond the wheel rim at each side of the wheel for positioning a bushing 82 thereon. The bushings assist in locating bearings 86 assembled in clusters at each end of the axle about the first portion 84 of reduced diameter.

A rotatable disc 88 includes a bore 90 formed therein which is parallel to and offset radially from a central axis of the disc for receiving the bearing clusters 86 therein so that the discs 88 are rotatably supported on the axle 78 about an eccentric axis of the discs. The discs 88 are each supported within a respective housing 92 for relative rotation therebetween.

The housings 92 are each fixed on the respective soft tail swing arms 94 forming the rear wheel mounts 22. A worm adjustment pin 94 communicates with gear teeth about a periphery of each disc 88 for controlling rotational position of the disc in relation to the surrounding housing whereby position of the offset bore locating the bearings and axle therethrough is also adjusted.

A locking member 96 surrounds an outer end of each disc 88 and includes a pair of eccentric locking screws therein to set the desired position of the disc eccentrically locating the axle therein.

A snap ring 100 is received within the bore in the rotatable discs 88 for retaining the bearing cluster 86 therein.

A second portion 102 of reduced diameter of the axle extends axially outward beyond the rear wheel mounts 22 and beyond the discs 88. The second portion 102 includes a slot for mating with a keyed locking insert 104 to which an axle nut 106 is secured by set screws 108.

An ornamental member 110 is again mounted at both outer ends of the axle for concealing the bearings and associated components. The ornamental member 110 includes an internal recess which fully surrounds the outer portion of the disc 88 supporting the bearings therein and the eccentric lock about an outer periphery thereof.

A through bore extends from the internal recess to an outer recess through which a mounting bolt 112 is received for threaded connection with an internal bore formed at the respective end of the axle. A suitable washer 114 surrounds the mounting bolt 112 for engagement with the ornamental member 110 to secure it to the end of the axle.

A suitable cap member 116 with associated sealing O-ring 118 are received within the external recess of the ornamental member 110 to fully conceal the mounting bolt and any other components associated with the axle. The second portion 102 of reduced diameter includes a slot formed therein for receiving a key 120 which fixes the ornamental member for rotation with axle.

Each of the ornamental members is considerably smaller in diameter than the associated wheel so as not to interfere with proper operation of the wheel.

The offset bores formed in the discs 88 of the rear wheel mounts permit position of the axle and bearings received therein to be adjusted in relation to the frame so that position of the drive belt pulley 74 on the rear wheel can be adjusted towards or away from the engine on the frame whereby tension on the drive belt about the pulley 74 can be adjusted while still permitting the axle to remain rotatable with the wheel relative to the frame and the ornamental members 110 supported at the ends of the axle to rotate with the wheel as well.

The system described herein entails using axles that are bound to the wheel with bearings located in the framework allowing the axle and wheel combination to rotate. With an extended axle configuration, an ornamental outboard hub is placed on the axle which in turn rotates with the wheel visually improving the overall aesthetic appeal of the motorcycle.

The scope of the design includes the additions of outboard axle hubs to both the front and rear axles of a motorcycle. In both instances, the hubs are locked to the rotating axle allowing them to rotate with the wheel itself.

The artistic merit of the design is for illustrative purposed only and not intended to limit the scope of the design. These and other objects of the present design will become more apparent to those skilled in the art throughout the foregoing and the following description. Various modifications could be made without departing from the true sprit and scope of the-proposed design.

As described above, with the axle keyed to the wheel and the bearings located in the lower fork tubes, the wheel hubs fastened to the axle ends will rotate with the wheel.

The rear wheel hubs serve the dual purpose of rotating with the rear wheel and also hiding the eccentric rear wheel aligning mechanism to give an overall finished look to the rear wheel.

Rear wheels typically contain double and triple bearing clusters. This system includes this criteria as the eccentric components will contain bearing clusters.

The eccentric alignment mechanism utilises a worm drive adjustment screw and a split threaded locking collar to lock the mechanism once proper belt/chain tension and wheel alignment is attained.

The bearing is housed in the lower fork tube backed up with an internal snap ring.

A keyed locking ring and nut set the axle and spacer against the bearing to prevent lateral movement of the wheel. The axle nut is redundantly locked to the locking ring via a setscrew.

The front hub is keyed to the protruding axle shaft and bolted in place. The cap with insignia is held in place in the hub with a compressed O-ring which fits machined grooves.

The hubs can be changed for aesthetic reasons without disturbing the set of the wheel and bearing configuration.

The triple cluster bearing configuration is housed in the eccentric bearing holder with the bearings backed up with an internal snap ring.

A keyed locking ring and nut set the axle and spacer against the bearings to prevent lateral movement of the wheel. The axle nut is redundantly locked to the locking ring via a setscrew.

The split locking collar is tightened to the housing block to prevent the eccentrics from rotating once adjusted.

The spinning hub is keyed to the protruding axle shaft and bolted in place. The cap with insignia is held in place in the hub with a compressed O-ring which fits machined grooves.

While one embodiment of the present invention has been described in the foregoing, it is to be understood that other embodiments are possible within the scope of the invention. The invention is to be considered limited solely by the scope of the appended claims.

1. A wheel support system for a two wheeled vehicle having a frame including a front wheel mount and a rear wheel mount each supporting a respective wheel therein, the system comprising:
at least one axle fixed for rotation with a respective one of the wheels;
bearings rotatably supporting said at least one axle on the respective wheel mount of the frame for rotation of said at least one axle in relation to the frame;
and a pair of ornamental members supported on respective free ends of said at least one axle for rotation relative to the frame.

2. The system according to claim 1 wherein the ornamental members are keyed for rotation with said at least one axle.

3. The system according to claim 1 wherein the ornamental members are secured to said at least one axle by threaded fastening means.

4. The system according to claim 1 wherein said at least one axle projects axially outward beyond the respective bearings at each end of the axle.

5. The system according to claim 1 wherein said at least one axle comprises a front axle fixed for rotation with the wheel supported on the front wheel mount.

6. The system according to claim 1 wherein said at least one axle comprises a front axle and a rear axle fixed for rotation with the wheels supported on the front wheel mount and the rear wheel mount respectively.

7. The system according to claim 1 wherein said at least one axle comprises a rear axle fixed for rotation with the wheel supported on the rear wheel mount.

8. The system according to claim 7 wherein there is provided adjustable mounting means for supporting the bearings on the rear wheel mount for adjusting spacing between the rear axle carried by the bearings and an engine of the vehicle.

9. The system according to claim 8 wherein the mounting means comprise a pair of discs, each having a bore formed therein which is parallel to and radially offset from a central axis of the respective disc which receives a respective end of the axle therein and each being supported on the frame for rotation about the central axis thereof.

10. The system according to claim 1 comprising a kit for modifying a conventional wheel rotatably supporting a conventional axle therein with conventional bearings, wherein said at least one axle includes mounting means for fixing the axle to the wheel in place of the conventional bearings and wherein there is provided a modified wheel mount supporting replacement bearings on the wheel mount in which the replacement bearings rotatably support said at least one axle therein.

11. A wheel support system for a two wheeled vehicle having a frame supported on a front wheel and a rear wheel and which supports an engine thereon, the system comprising:
an axle supporting the rear wheel thereon; and
a rear wheel mount including a pair of discs, each having a bore formed therein which is parallel to and radially offset from a central axis of the respective disc which receives a respective end of the axle therein and each being supported on the frame for rotation about the central axis thereof;
whereby distance between the axle and the engine is varied as the discs are rotated relative to the frame.

12. The system according to claim 11 wherein there is provided locking means for selectively restricting rotation of the discs relative to the frame.

13. The system according to claim 12 wherein the locking means includes a worm gear engaging peripheral teeth on each disc to control rotational position of the discs.

14. The system according to claim 11 wherein the axle is fixed to the rear wheel for rotation therewith and wherein there are provided bearings rotatably supporting the axle within the bores in the discs.

15. The system according to claim 11 wherein there is provided a pair of ornamental members supported on respective free ends of the axle for rotation relative to the frame.

16. A method of modifying a motorcycle comprising a frame, a front wheel rotatably supported on a front axle mounted on a front wheel mount and a rear wheel rotatably supported on a rear axle mounted on a rear wheel mount, the method comprising:
fixing at least one axle to rotate with the respective wheel;
supporting said at least one axle for rotation relative to the respective wheel mount.

17. The method according to claim 16 including supporting said at least one axle to extend axially outward beyond the respective wheel mount.

18. The method according to claim 17 including supporting an ornamental member at each end of said at least one axle.

19. The method according to claim 18 including fixing the ornamental members to rotate with said at least one axle.
